(19) United States
(12) Patent Application Publication
(10) Pub. No.: US 2009/0251725 A1
(43) Pub. Date: Oct. 8, 2009

(54) PRINTING CONTROL APPARATUS AND PRINTING CONTROL METHOD

(75) Inventors: Tetsuya KUWAHARA, Kyoto-shi (JP); Yoshiaki TANISAKA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/363,854

(22) Filed: Feb. 2, 2009

(30) Foreign Application Priority Data
Apr. 3, 2008 (JP) 2008-097209

(51) Int. Cl. G06F 3/12

(52) U.S. Cl. 358/1.15

(57) ABSTRACT

In a printing control method arranged to control a printer via a network by using a computer, stored print setting data is referred to when direct printing is specified, either one of original document data and print data in which the original document data is described in a page description language is selected as data to be transmitted to the printer, the original document data is transmitted to the printer when the original document data is selected, and the original document data is converted into the page description language and then transmitted to the printer when the print data is selected.

### CROSS-REFERENCE TO RELATED APPLICATIONS

This application claims priority under 35 U.S.C. 119 to Japanese Patent Application No. 2008-097209, filed on Apr. 3, 2008, which application is hereby incorporated by reference in its entirety.

### BACKGROUND OF THE INVENTION

1. Field of the Invention

The present invention relates to a printing control apparatus and a printing control method that can directly transmit data to be printed to a printer without through a printer driver.

2. Description of the Related Art

Recently, a printer that responds to direct printing in which a Personal Computer (PC) or other similar device can directly transmit original document data to the printer has been provided. In the direct printing, the printer directly rasterizes the original document data transmitted from the PC and then outputs a printed material.

Through the direct printing, a client, such as the PC, can print the original document data without converting the data into print data that is described in a Page Description Language (PDL), such as a POSTSCRIPT (registered trademark). Therefore, direct printing is advantageous in that the printing can be performed without consuming a large amount of hardware resources (such as a micro processor and a memory, for example) of the PC.

However, the fact that print settings for the direct printing are limited by contents depending on hardware of the printer or by the number of print sets, etc. is a problem. In other words, combined printing in which the layout of the original document data is changed cannot be performed in the direct printing.

A printing system in which various print settings can be made at the time of direct printing has been disclosed in the conventional art. Utility software that enables the direct printing is installed on the client. When an option regarding drawing, such as background pattern printing, is specified, the utility software regenerates a file for which the direct printing has been specified in accordance with the specified option. The regenerated file is encrypted, and then the encrypted file and a decryption key are transmitted to the printer.

However, in the conventional printing system, it is difficult to completely match functions of the utility software with functions of a printer driver. Accordingly, in accordance with the contents of the print settings, a user needs to select the direct printing or normal printing that uses the printer driver.

### SUMMARY OF THE INVENTION

In order to overcome the problems described above, preferred embodiments of the present invention provide a printing control apparatus and a printing control method in which it is not necessary to select a direct printing process or a normal printing process.

A preferred embodiment of the present invention provides a printing control apparatus that is connected with a printer via a network. The printing control apparatus preferably includes a setting information memory unit arranged to store print setting data regarding direct printing in which original document data is output to the printer; a transmit data selection unit arranged to refer to the print setting data when the direct printing has been specified, and then to select, as data to be transmitted to the printer, either one of the original document data and print data in which the original document data is described in a PDL; and a data conversion unit arranged to convert the original document data based on the print setting data into the print data in accordance with the selection of the transmit data selection unit.

According to a preferred embodiment of the present invention, when the print setting data includes data that commands a process that cannot be executed through the printer to be performed, the transmit data selection unit selects the print data as the data to be transmitted, and when the print setting data does not include such command data, the transmit data selection unit selects the original document data.

Further, a preferred embodiment of the present invention provides a reset unit arranged to store conversion setting data in which settings of the data conversion unit are recorded, and to reset the settings of the data conversion unit back to its initial state by using the conversion setting data when the original document data is converted by the data conversion unit based on the print setting data.

Moreover, according to a preferred embodiment of the present invention, a computer connected with the printer via the network stores the print setting data regarding the direct printing in which the original document data is output to the printer, refers to the print setting data when the direct printing is specified, selects, as the data to be transmitted to the printer, either one of the original document data and the print data in which the original document data is described in the PDL, and then converts the original document data based on the print setting data into the print data in accordance with the selection.

According to a preferred embodiment of the present invention, the printing control apparatus or the printing control method selects, as the data to be transmitted to the printer, either one of the original document data and the print data in accordance with the contents of the print setting data. In other words, setting information regarding creation of the print data can be recorded in the print setting data that relates to the direct printing. Thus, a user of the printing control apparatus and the printing control method of the present invention can create printouts that correspond to various print settings without selecting the direct printing or the normal printing process.

According to a preferred embodiment of the present invention, when the data conversion unit converts the original document data based on the print setting data, the printing control apparatus and the printing control method of the present invention reset back the settings of the data conversion unit. Therefore, the settings of the data conversion unit can be prevented from being in the state that has been changed in accordance with the direct printing specification.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a diagram of a network system according to a preferred embodiment of the present invention.

FIG. 2 illustrates a setting screen for direct printing according to a preferred embodiment of the present invention.

FIG. 3 is a flowchart of an operation of a direct printing unit according to a preferred embodiment of the present invention.

FIG. 4 is a flowchart of a print data transmitting process according to a preferred embodiment of the present invention.

FIG. 5 is a flowchart of an original document data transmitting process according to a preferred embodiment of the present invention.

### DETAILED DESCRIPTION OF THE PREFERRED EMBODIMENTS

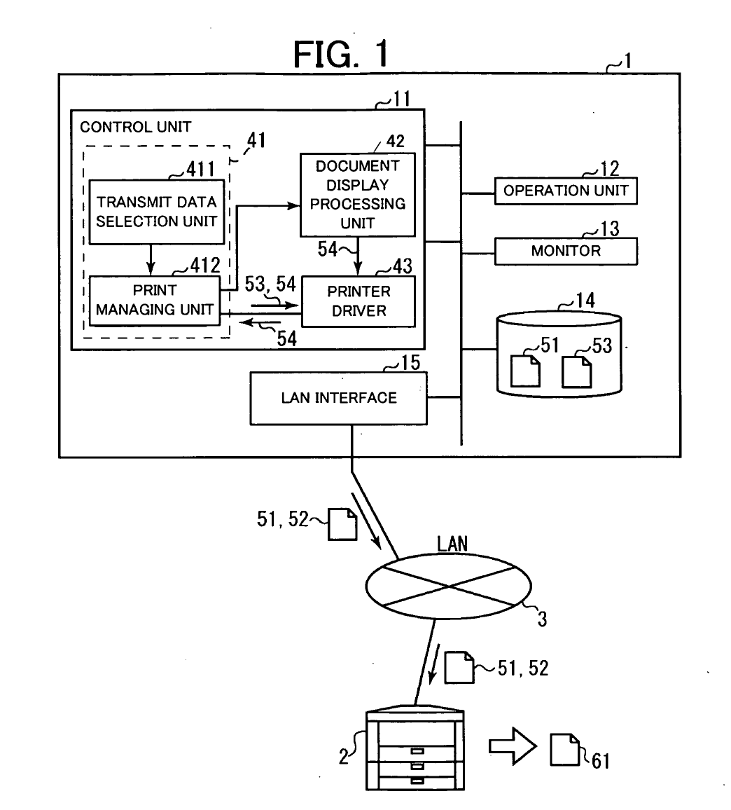

Preferred embodiments of the present invention will be described below with reference to the drawings. FIG. 1 is a diagram of a network system according to a preferred embodiment of the present invention. In the network system of FIG. 1, a PC 1 and a printer 2 are connected with a Local Area Network (LAN) 3. Such a network system is provided in an office, for example, and the printer 2 is used by users at the office.

The PC 1 is a terminal device used by the user and can use the printer 2 via the LAN 3. The printer 2 can preferably perform direct printing and a normal printing process that uses a printer driver 43. A router arranged to connect to the Internet or other LANs is preferably provided in the LAN 3.

A configuration of the PC 1 will be described first. The PC 1 preferably includes a control unit 11, an operation unit 12, a monitor 13, a memory unit 14, and a LAN interface 15. The control unit 11 includes a direct printing unit 41, a document display processing unit 42, the printer driver 43, a micro processor (not illustrated), and a memory (not illustrated).

The direct printing unit 41, the document display processing unit 42, and the printer driver 43, which are illustrated as elements of the control unit 11 in FIG. 1, can be preferably implemented through programs that are installed on the PC 1, for example. Such programs are preferably stored in the memory unit 14. In other words, the direct printing unit 41, the document display processing unit 42, and the printer driver 43 are implemented through hardware resources such as the micro processor and the memory.

The direct printing unit 41 executes direct printing in accordance with user's instructions. The direct printing unit 41 preferably includes a transmit data selection unit 411 and a print managing unit 412. The transmit data selection unit 411 is arranged to select whether to transmit original document data 51 directly to the printer 2 or to transmit the original document data 51 to the printer 2 after converting the data into print data 52 in which the original document data 51 is described in a PDL. The print managing unit 412 is arranged to control the printer driver 43 or the transmission of the original document data 51.

The document display processing unit 42 is arranged to display the original document data 51 on the monitor 13. The user can instruct the printing of the original document data 51 by using the operation unit 12. In such a case, the original document data 51 is printed in a normal process that uses the printer driver 43. The printer driver 43 converts the original document data 51 into the print data 52 in accordance with instructions from the print managing unit 412, and then transmits the print data 52 to the printer 2.

The operation unit 12 includes a mouse and a keyboard, or other suitable units. A Liquid Crystal Display (LCD) can be used as the monitor 13, for example. The user operates the PC 1 by using the operation unit 12 and the monitor 13 as user interfaces.

The memory unit 14 includes a hard disk drive etc. and stores the original document data 51 and various programs, or the like. The original document data 51 includes document data created by the user operating the PC 1 or image data acquired through the Internet, or the like. The original document data 51 may be in a Portable Document Format (PDF), for example.

The LAN interface 15 transmits/receives data to/from each computer that is connected to the LAN 3 or the like through a Transmission Control Protocol (TCP)/Internet Protocol (IP).

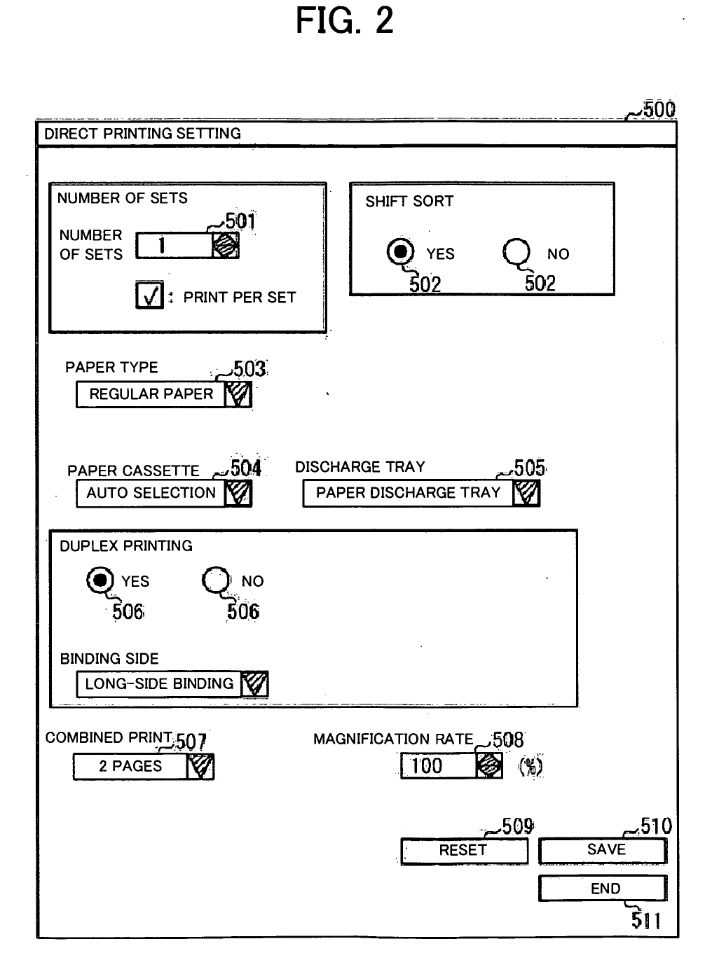

An operation of the direct printing unit 41 of the PC 1 having the above-described configuration will be described with reference to FIGS. 2 through 5.

First, before instructing the PC 1 to perform the direct printing, the user needs to input the settings for the direct printing. The print managing unit 412 displays a setting screen 500 of the direct printing on the monitor 13 in accordance with the user's operation.

FIG. 2 illustrates an example of the setting screen 500 of the direct printing according to a preferred embodiment of the present invention. In the setting screen 500 of FIG. 2, each setting item such as the number of sets, a shift sort, a printing paper type, a paper cassette, a discharge tray, and duplex printing is related to the hardware control of the printer 2. Meanwhile, setting items regarding the number of combined pages and a print magnification rate require a drawing function of the printer driver 43 depending on a set value.

A number-of-sets setting menu 501 is used to specify the number of sets of print documents 61 to be printed through the printer 2. When a plurality of sets is specified through the number-of-sets setting menu 501, the user can specify whether or not to print the print documents 61 per set. A button is preferably used as a shift sort setting button 502. When the shift sort setting button 502 is set to output a plurality of sets of print documents 61 per set, the shift sort setting button 502 is used to specify whether or not to execute a shift sort operation. The shift sort is a function of changing, with respect to each set, a position where the print document 61 is output in the discharge tray.

A paper type setting menu 503 is preferably used to specify a type of a printing paper, such as a regular paper and a high-quality paper, for example. A paper cassette specifying menu 504 is preferably used to specify a paper cassette in which the printing papers are stored. A discharge tray specifying menu 505 is preferably used to specify a tray to which the print documents 61 are discharged. A pull-down menu is preferably used as the paper type setting menu 503, the paper cassette specifying menu 504, and the discharge tray specifying menu 505. A button is preferably used as a duplex printing setting button 506, which is used to specify whether or not to perform a duplex printing operation.

A combined printing setting menu 507 is preferably used to specify the number of pages to be printed on one piece of printing paper. When at least “two” pages are specified in the combined printing setting menu 507, a combined printing operation is performed with the specified pages. A pull-down menu is preferably used as the combined printing setting menu 507. A magnification rate setting menu 508 is preferably used to specify a print magnification rate of the original document data 51 to be printed on the printing paper. When the print magnification rate is set to be other than 100%, an enlarged printing operation or a reduced printing operation is performed based on the specified magnification rate.

The user inputs each setting information to the setting screen 500 by using the operation unit 12. By pressing a reset button 509, the user can return the display of the setting screen 500 to an initial state. The initial state here displays the print settings that are applied to the printing of the original document data 51 when the original document data 51 is directly transmitted to the printer 2.

When a save button 510 is pressed, the print managing unit 412 saves each setting information displayed on the setting screen 500 as direct printing setting information 53. The user presses an end button 511 to end the settings for the direct printing.

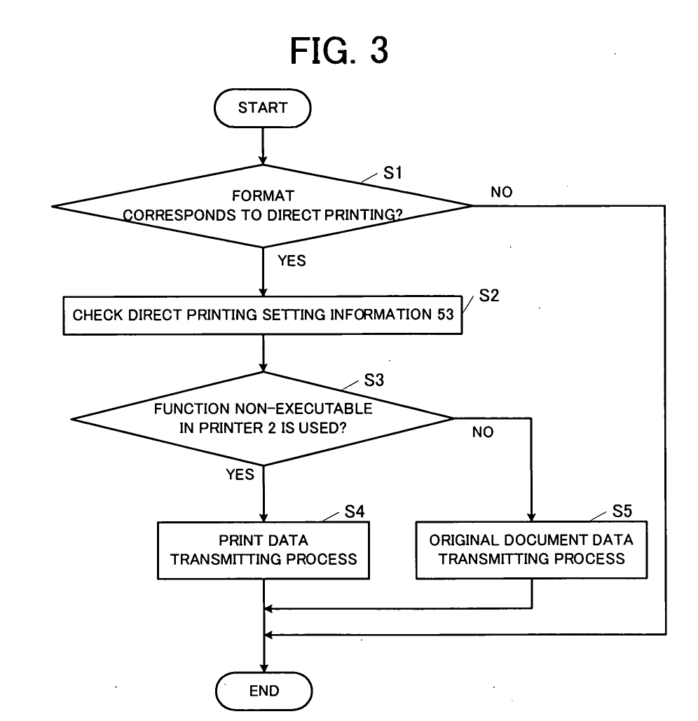

FIG. 3 is a flowchart of an operation of the direct printing unit 41 according to a preferred embodiment of the present invention. When the user operates the operation unit 12 to specify the direct printing of the original document data 51, the direct printing unit 41 is activated. For example, by moving an icon indicating the original document data 51 to an icon indicating the direct printing unit 41 displayed on the monitor 13, i.e., by performing a drag and drop operation, the direct printing of the original document data 51 can be specified.

The transmit data selection unit 411 is used to check whether or not a format of the original document data 51 corresponds to the direct printing (step S1). When the format of the original document data 51 does not correspond to the direct printing (“NO” in step S1), the transmit data selection unit 411 ends a process of FIG. 3. When the format of the original document data 51 corresponds to the direct printing (“YES” in step S1), the transmit data selection unit 411 checks the direct printing setting information 53 (step S2).

When the settings that cannot be handled through the printer 2 are recorded in the direct printing setting information 53 (“YES” in step S3), the transmit data selection unit 411 selects the transmission of the print data 52 to the printer 2. More specifically, when at least one of the combined printing, the enlarged printing, and the reduced printing is selected in the direct printing setting information 53, the print data 52 is selected as the data to be transmitted to the printer 2. This is because when the printer 2 executes the combined printing, the enlarged printing, and the reduced printing, the drawing function of the printer driver 43 is needed. The print managing unit 412 transmits the print data based on the selection made through the transmit data selection unit 411 (step S4).

When only the settings that can be handled through the printer 2 are recorded (“NO” in step S3), the continuation of the direct printing is determined through the transmit data selection unit 411. Based on the determination of the transmit data selection unit 411, the original document data 51 is transmitted to the printer 2 (step S5). In the direct printing setting information 53, when the settings that depend on the hardware of the printer 2 are recorded, and when the settings regarding the drawing function of the printer driver 43 are not recorded, the transmit data selection unit 411 selects the transmission of the original document data 51.

Thus, the format of the data to be transmitted to the printer 2 is selected through the direct printing unit 41 based on the contents of the direct printing setting information 53. Accordingly, the user can specify the normal printing process performed via the printer driver without activating the document display processing unit 42.

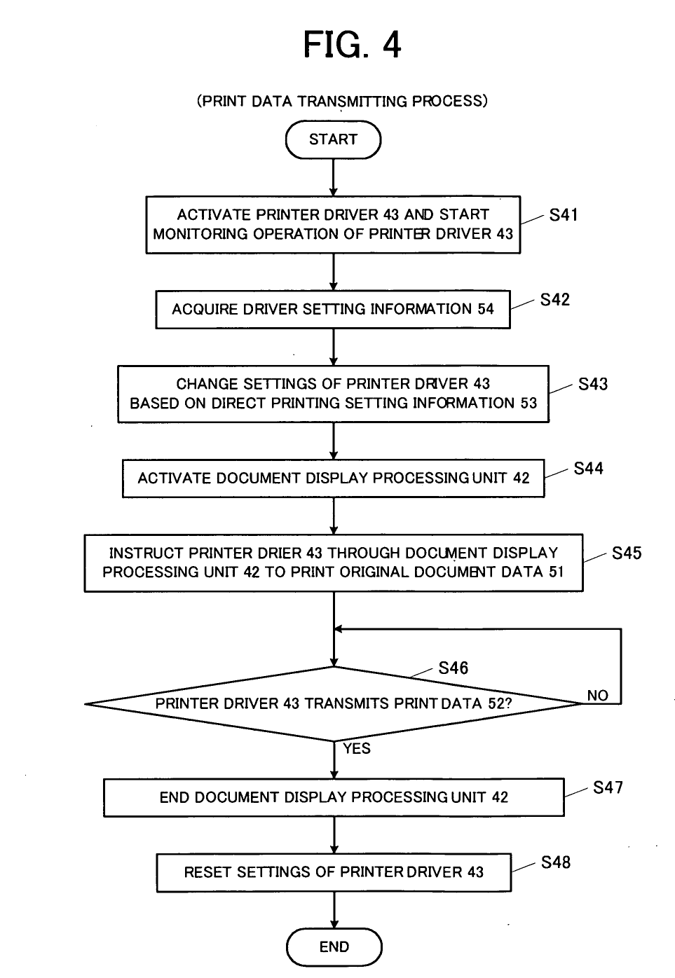

Next, a print data transmitting process of step S4 according to a preferred embodiment of the present invention will be described. FIG. 4 is a flowchart of the print data transmitting process (step S4). First, the print managing unit 412 activates the printer driver 43 and starts monitoring the operation of the printer driver 43 (step S41). The print managing unit 412 acquires driver setting information 54 from the printer driver 43 (step S42), and then stores the acquired driver setting information 54. The driver setting information 54 relates to various parameters that are set through the printer driver 43. The settings of the printer driver 43 may be changed based on the direct printing setting information 53 (step S43).

The print managing unit 412 activates the document display processing unit 42 (step S44). Association information in which an extension that is added to a file name of the original document data 51 is associated with a program name of the document display processing unit 42 is stored in the print managing unit 412. By using the association information, the print managing unit 412 can activate the document display processing unit 42 that corresponds to the original document data 51. The document display processing unit 42 is operated as a background process.

Next, the print managing unit 412 instructs the printer driver 43 via the document display processing unit 42 to print the original document data 51 (step S45). More specifically, the original document data 51 and a command regarding the printing of the original document data 51 are transferred from the document display processing unit 42 to the printer driver 43 through an operating system (not illustrated) that is operated through the control unit 11.

The print data 52 is created from the original document data 51 through the printer driver 43 based on the contents of the direct printing setting information 53. The print data 52 is transmitted from the printer driver 43 to the printer 2 via the LAN interface 15. The printer 2 rasterizes the print data 52 and outputs the document 61 on which the original document data 51 is printed.

When the transmission of the print data 52 is confirmed through the printer driver 43 (“YES” in step S46), the print managing unit 412 ends the operation of the document display processing unit 42 (step S47). By using the driver setting information 54 acquired in step S42, the print managing unit 412 resets back the settings of the printer driver 43 (step S48), and then ends the operation of the printer driver 43. Thus, the print managing unit 412 can reset back the settings of the printer driver 43, and prevent a change of the settings of the printer driver 43 that goes against the intention of the user.

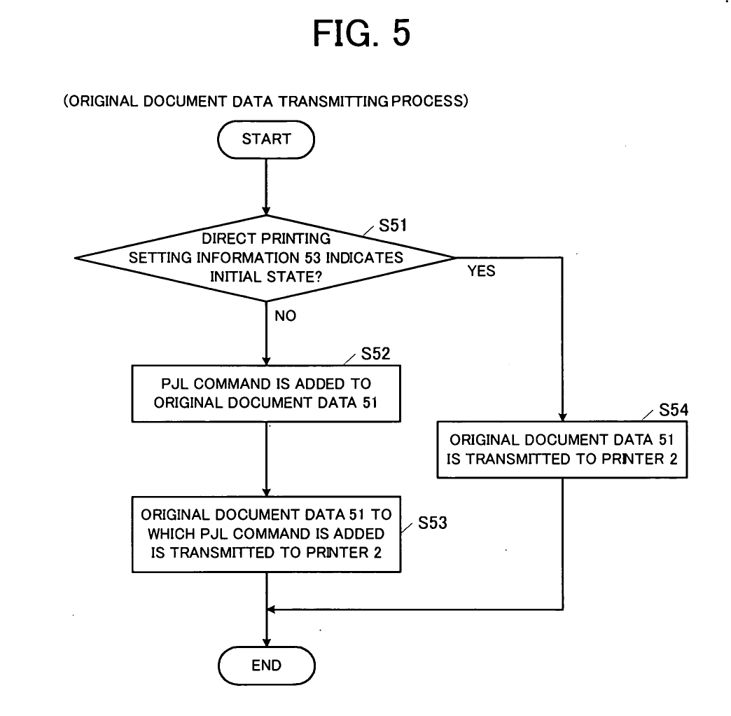

Next, the original document data transmitting process according to a preferred embodiment of the present invention will be described with reference to FIG. 5. FIG. 5 is a flowchart of the original document data transmitting process (step S5).

When the direct printing setting information 53 does not show the initial state of the setting screen 500 (“NO” in step S51), the print managing unit 412 adds command data corresponding to the direct printing setting information 53 to the original document data 51 (step S52). The command data is described based on a Printer Job Language (PJL). The print managing unit 412 transmits, to the printer 2, the original document data 51 to which the command data is added (step S53). The printer 2 rasterizes the original document data 51, and then prints in accordance with the added command.

When the direct printing setting information 53 shows the initial state of the setting screen 500 (“YES” in step S51), the print managing unit 412 transmits the original document data 51 to the printer 2 (step S54). At this time, the command is not added to the original document data 51. The printer 2 rasterizes the original document data 51, and then outputs the document 61 on which the original document data 51 is printed.

As described above, in the present preferred embodiment, in accordance with the contents of the direct printing setting information 53, the direct printing unit 41 selects either one of the original document data 51 and the print data 52 as the data to be transmitted to the printer 2. Therefore, not only the setting information that is applied to the direct printing but also the setting information regarding the function of the printer driver 43 can be recorded in the direct printing setting information 53. Accordingly, when printing the original document data 51, the user does not need to select the direct printing or the normal printing process that uses the printer driver, which thereby can improve the user friendliness.

In the present preferred embodiment, the example in which the drag and drop is used to specify the direct printing has been described, but the present invention is not limited to such an example. For example, the user can display the selection screen of the data commands to execute the direct printing by double-clicking an icon that indicates the direct printing unit 41.

In the present preferred embodiment, the example in which the transmit data selection unit 411 selects the transmission of the print data 52 when the combined printing, the enlarged printing, and the reduced printing are set has been described, however, the present invention is not limited to such an example. The transmit data selection unit 411 can select the data to be transmitted to the printer 2 based on capability of the printer 2 and functions of the printer driver 43.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A printing control apparatus that is connected with a printer via a network, comprising:
a setting information memory unit arranged to store print setting data that relates to direct printing in which original document data is output to the printer;
a transmit data selection unit arranged to refer to the print setting data when the direct printing is specified, and then to select either one of the original document data and print data in which the original document data is described in a page description language as data to be transmitted to the printer; and
a data conversion unit arranged to convert the original document data into the print data based on the print setting data in accordance with the selection of the transmit data selection unit.

2. The printing control apparatus according to claim 1, wherein
the transmit data selection unit selects the print data as the data to be transmitted when the print setting data includes data that commands to perform a process that cannot be executed through the printer; and
the transmit data selection unit selects the original document data as the data to be transmitted when the print setting data does not include such command data.

3. The printing control apparatus according to claim 1, further comprising a setting reset unit arranged to store conversion setting data in which settings of the data conversion unit are recorded, and to then reset the settings of the data conversion unit back to an initial state by using the conversion setting data when the original document data is converted by the data conversion unit based on the print setting data.

4. The printing control apparatus according to claim 1, further comprising:
a print job language generation module arranged to generate a print job language based on the print setting data; and
a print job language adding module arranged to add the print job language generated through the print job language generation module to the original document data.

5. The printing control apparatus according to claim 1, further comprising a print setting module arranged to set the print setting data.

6. The printing control apparatus according to claim 5, further comprising a monitor arranged to display a screen for setting the print setting data.

7. A printing control apparatus that is connected with a printer via a network, comprising:
a device arranged to store print setting data that relates to direct printing in which original document data is output to the printer;
a device arranged to refer to the print setting data when the direct printing is specified, and to select, as data to be transmitted to the printer, either one of the original document data and print data in which the original document data is described in a page description language; and
a device arranged to convert the original document data into the print data based on the print setting data in accordance with the selection of the transmit data selection unit.

8. The printing control apparatus according to claim 7, wherein when the print setting data includes data that commands a process that cannot be executed through the printer to perform, the print data is selected as data to be transmitted, and when the print setting data does not include such command data, the original document data is selected as the data to be transmitted.

9. The printing control apparatus according to claim 7, further comprising a device arranged to store conversion setting data in which settings of the data conversion unit are recorded, and to reset the settings of the data conversion unit back by using the conversion setting data when the original document data is converted by the data conversion unit based on the print setting data.

10. The printing control apparatus according to claim 7, further comprising:
a device arranged to generate a print job language based on the print setting data; and
a device arranged to add the generated print job language to the original document data.

11. The printing control apparatus according to claim 7, further comprising a device arranged to set the print setting data.

12. The printing control apparatus according to claim 11, further comprising a device arranged to display a screen for setting the print setting data.

13. A printing control method arranged to control a printer via a network by using a computer, comprising the steps of:
referring to stored print setting data when direct printing is specified;
selecting, as data to be transmitted to the printer, either one of original document data and print data in which the original document data is described in a page description language;
transmitting the original document data to the printer when the original document data is selected; and
converting the original document data into a page description language, and then transmitting the page description language to the printer when the print data is selected.

14. The printing control method according to claim 13, further comprising the steps of:
determining whether or not the printer corresponds to the direct printing; and
ending a process when the method determines that the printer does not correspond to the direct printing.

15. The printing control method according to claim 13, further comprising the steps of:
displaying a setting screen of the print setting data; and
changing the print setting data from initial setting data.

16. The printing control method according to claim 13, further comprising the steps of:
determining whether or not the stored print setting data is the initial setting data;
transmitting the original document data to the printer when the print setting data is the initial setting data;
generating a print job language based on the print setting data when the print setting data is not the initial setting data; and
adding the print job language to the original document data and transmitting the original document data to which the print job language has been added.

17. The printing control method according to claim 16, further comprising a step of resetting back the changed print setting data to the initial setting data.

18. The printing control method according to claims 13, further comprising the steps of:
determining whether or not the print setting data includes data that commands to perform a process that cannot be executed through the printer;
selecting the print data when the print setting data includes such command data; and
selecting the original document data when the print setting data does not include such command data.

19. The printing control method according to claim 15, further comprising a step of displaying a button on a setting screen.

20. The printing control method according to claim 15, further comprising a step of displaying a pull-down menu on the setting screen.
